(19) United States
(12) Patent Application Publication
(10) Pub. No.: US 2010/0194533 A1
(43) Pub. Date: Aug. 5, 2010

(54) Method and apparatus for encoding railroad ties and other railroad track components

(76) Inventors: Henry W. Sullivan, Houston, TX (US); William Gordon Rogers, St. George, UT (US)

Correspondence Address: THE MATTHEWS FIRM, 2000 BERING DRIVE, SUITE 700, HOUSTON, TX, 77057, US

(21) Appl. No.: 12/322,186

(22) Filed: Jan. 30, 2009

(51) Int. Cl. H04Q 5/22

(52) U.S. Cl. 340/10.1

(57) ABSTRACT

There is provided an apparatus and method for storing and retrieving information concerning railroad ties or other railroad components. The apparatus preferably allows for information to be stored and retrieved. The stored information can be coded or non-coded. In one embodiment, a transponder is embedded in or attached to a railroad tie or other component that is capable of storing information concerning the component or tie and a reader, for retrieving the information, from the transponder, is provided. The transponder may utilize radio frequency identification (RF-ID) technology. The reader preferably generates and transmits radio frequency waves to the transponder, and the transponder broadcasts the information stored therein in response thereto. The reader may be carried by a rail car, a storage yard vehicle, can be manually transported, or other by other methods so that the reader moves within radio frequency (R.F.) activating range of the transponder in each component or tie. The transponder may be a read-only or a read-write transponder as well as have a variety of security functions to prevent access by unauthorized users and to prevent inadvertent or unauthorized changes in the stored data.

### TECHNICAL FIELD OF THE INVENTION

This invention relates, generally, to railroad track systems and specifically, to storing and retrieving information regarding components in railroad track systems and methods for using same. The invention relates more specifically to storing information about railroad ties within the tie or on the tie in the railroad track system regarding, for example, and throughout manufacturing, stockpiling, transfer, installation, use and condition for the life of the railroad tie. Additionally, the invention pertains to the retrieval, and if desired, the transmission, of said information, from the railroad ties.

### BACKGROUND OF THE INVENTION

The maintenance of railroad equipment has long been a significant problem. Particularly, the repair and maintenance of the track structural components is a problem. And with respect to the track structural components, the repair and maintenance of the ties is a huge problem.

Railroad track structural components, in general, and railroad ties, in particular, are oftentimes contributing factors in rail car failures and accidents causing injuries, loss of the freight materials, loss of revenue, and loss of rail line availability, causing monetary damages sometimes in the millions of dollars. It would be very desirable that such railroad track components be properly identified as to the source of manufacture the particulars about manufacture, types of materials used in the production batch, date of manufacture, the distributor, date of installation, installer, and various other information about the history of the component.

Railroad track components, and particularly railroad ties typically have a limited life and must be replaced over time due to wear or degradation. Knowing the age and history of each component would be an asset for preventative maintenance of rail lines. However, the source and history of the ties or other components of the rail line is often difficult to follow. Often any markings or tags on components, and particularly ties, become dislodged, illegible, or are buried during the installation of the rail line. Furthermore, the task of recording each component by hand either during or after installation is very labor intensive. As a result, railroad maintenance personnel have limited information upon which to plan maintenance of the lines, and accident investigators have little information regarding the source and history of the components that may contribute to an accident or equipment failure.

The limited information upon which to plan the maintenance of the railroad lines has been, and continues to be, a problem recognized by those in the field of track operation and maintenance. The problem of planning maintenance of the railroad lines has been a significant problem, but as yet an unsolved problem. The problem of the limited information upon which to plan the maintenance of the railroad lines has existed for as long as railroads have existed.

There have been many proposed solutions to this problem. Many people have tried many proposed solutions over a long period of time. Nail-on labels have been tried. However, nail-on labels are ineffective because they often fall off over time. Painting letters, numbers or the like is ineffective because of wearing off due to weather or tie movement, and burying upon installation. Etching the letters, numbers, or the like is generally ineffective because the etching becomes filled in with dirt or is worn off. These methods also share the common problem of requiring a person to walk the track and manually record the data. All of these techniques also require large human capital and are not generally efficient for cataloging the age, composition, source, installation, location, etc. of the particular component.

The prior efforts to solve this long felt problem includes several patents to Michael A. Bryan, which disclose methods and apparatuses for monitoring railway defects in which a rail car or a plurality of rail cars carries a variety of sensors, such as a tilt sensor and an accelerometer. The sensors detect defects occurring in the track or its underlying support system as the rail car travels over it. A remote tracking station receives, stores, and monitors data on the track condition obtained by the sensors, and analyzes the information over time. Bryan also discloses a global positioning system (GPS) sensor for tracking the geographic location of the moving rail car over time. There is also art, which discloses an automated track inspection vehicle that uses primarily visual inspection and cameras to inspect railroad tracks and components. However, the prior efforts do not disclose the reading of information previously stored in a railroad component, allowing updated information to be placed in the railroad component, or any reliable way to track, over time, the history of any particular component.

### BRIEF DESCRIPTION OF THE DRAWINGS

For a further understanding of the nature and objects of the present invention, reference should be had to the following detailed description, taken in conjunction with the accompanying drawings, in which like elements are given the same or analogous reference numbers.

FIG. 1 illustrates a pictorial view of the end of a railroad tie and car equipped with the tracking system in accordance with the present invention;

FIG. 2 illustrates a schematic diagram of a radio frequency identification (RF-ID) system in accordance with the present invention;

FIG. 3 illustrates a circuit diagram for an RF-ID reader and transponder used in accordance with the present invention;

FIG. 4 illustrates the F.M. (Frequency Modulation) principle used for the read function of a transponder in accordance with an embodiment of the present invention;

FIG. 5 illustrates the format of received data for a read-only transponder in accordance with an embodiment of the present invention;

FIG. 6 illustrates the format of a read-write transponder in accordance with an embodiment of the present invention;

FIG. 7 illustrates a satellite global positioning system and remote receiver in accordance with an embodiment of the present invention;

FIG. 8 illustrates ties with attached and embedded storage devices in accordance with an embodiment of the present invention;

FIG. 9 illustrates ties in a typical storage lot (stacks of ties) in accordance with an embodiment of the present invention; and

FIG. 10 illustrates a tie with a sensor for determining tie condition and/or wear in accordance with an embodiment of the present invention.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### DETAILED DESCRIPTION OF THE PREFERRED EMBODIMENT

To overcome the persistent problems that have plagued the railroad industry for a long time, and to achieve the objects, features and advantages of the present invention, and in accordance with the purpose of the invention as embodied and broadly described herein, an apparatus and method for storing information associated with components of a track system, including but not limited to a railroad tie, is disclosed and comprises an information storing device affixed to or embedded in the railroad tie or other component; and wherein the stored information comprises information about the manufacture or use of the component. The stored information can be retrieved and/or transmitted, and the information can be stored in memory in coded or uncoded form. Virtually any devices known or used by one skilled in the art can be used to store and retrieve the information about the railroad component, as long as the storage device can be affixed to or near the surface of the component or embedded in the component. It should be understood, that this technology can be used as well in may varied applications where certain desired information, particularly about a variety of structural members, is needed or desired.

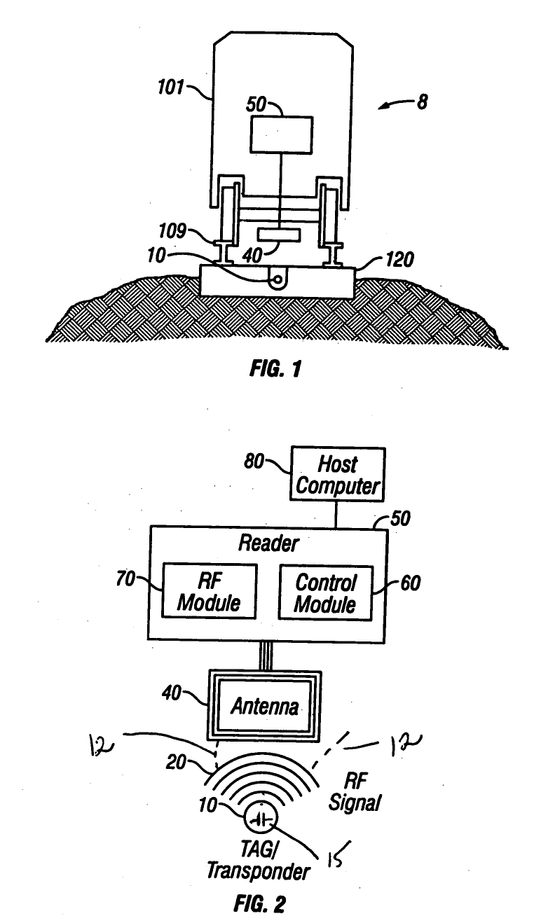

Referring now to the drawings, and more particularly to FIG. 1, there is shown an end view of a portion of a railroad track system, generally designated 8, according to one embodiment of the present invention. In FIG. 1, the railroad track system 8 includes a rail car 101, the tracks 109 and the ties 120. The reader 50 has an antenna 40 that is attached to or associated with a rail car 101. The tag or transponder 10 is embedded within, or affixed to, the surface of the tie 120. As the rail car 101 passes over the tie 120, or within proximity of the tie, the reader 50 sends a signal to the transponder 10 through the antenna 40. In response, the transponder 10 transmits back to the reader 50 through the antenna 40 data or information that has been programmed or stored into the transponder 10.

According to various embodiments of the invention, this stored information includes, but is not limited to, information about the manufacturer, sale, use, and condition, and wear of the tie 120. In one embodiment, the manufacturer initially writes or transmits information to the storage device or transponder 10 regarding particulars about manufacture, such as tie composition, the identity of the manufacturer of the tie 120, the date of manufacture, the production batch, the date of installation of the tie, the tie identification number, the identity of the installer, as well as subsequent information about the use and the history of the tie 120, and other information that can be input and stored in the memory device such as a tag, chip, or transponder. Examples of further information regarding the history of the railroad ties that might be written into the transponder include the identity tie installer (or installation crew), the date installed, and the last date(s) inspected.

Subsequently, the railroad company or other authorized entity reads and writes to the tie transponder when and/or after the tie is installed. The information thus written and then read is then recorded preferably with the location information concerning the tie. Further, the location can be listed as a GPS generated location, and any other location scheme that yields a verifiable and reproducible location. If desired, information about the tie condition and wear can also be monitored by sensors placed on or in the tie that detect internal or external fractures, damage, corrosion, and wear. Also, automated inspection devices can be placed on railcars and other such moving carts and vehicles to provide such information. The information about the tie condition and/or the wear can also be stored in the tie or transmitted to other locations for review, cataloging and storage. The information to be stored can also be encoded, if desired to save space and for efficiency, and can also be encrypted for security. As used herein, encryption means a process for scrambling electronic files into an unreadable format using, for example, a mathematical algorithm. Additionally, safeguards, such as passwords, can also be used to prevent unauthorized writings to the ties. Further, at least some of the information written to the transponder will be in a Read-Only (RO) format so as to prevent unintentional deletion and/or alteration of historical information as described hereinabove. Thus, certain data such as, but not limited to, manufacturing, installation and other equipment-related data will always remain with the particular railroad tie or other railroad component.

Referring now to FIG. 2, in one embodiment of the invention, radio frequency identification (RF-ID) technology is utilized. The core of the RF-ID system is the encodable “tag” or “transponder” 10 which can be attached to or embedded within an object such as the railroad tie 120. The transponder 10 is loaded with information about the tie 120 either before or after the tag or transponder is affixed to or embedded in the tie 120. The methods for encoding radio frequency transponders with information are well known in the art. The data that is stored may be converted into a series of codes, in contrast to uncompressed, uncoded analog. As used herein, encode is defined as the process of representing information content and structure into a format suitable for transfer or storage. Also when the data is converted by the use of a code or a coded set, it is done so in such a manner that reconversion to the original form is possible.

If the stored information is encoded, it is preferably “read” as follows. A portable RF-ID reader 50 is moved within proximity to the tie 120, such as within a few inches to several feet and transmits a radio frequency wave through the antenna 40 that is detected by at least one transponder 10 within or upon the tie. The transponder 10 broadcasts back through the RF signal 20 its stored data to the reader 50. The reader 50 may include a control module 60 and an RF module 70. The transponder 10 is preferably battery free. However, those skilled in the art can appreciate that as technology and nano-technology advances, power systems for both the reader 50 and or the transponder 10 may become available to provide much better communication systems that will work even under the adverse conditions to which the track system may be exposed and as such should not be viewed as a limitation herein. Further, the reader 50 or the transponder 10 can comprise radioactive or nuclear material that may serve as the data source, which allows the input and reading of various data information including, but not limited to, digital data. The system of FIG. 2 illustrates, without limitation, two separate antennas, one from the transponder 10, the antenna 12, and the other antenna 40 on or interfaced with the reader 50. Of course, the antenna used to transmit information to the reader may also be configured or interfaced with the readers in other ways known to one skilled in the art, and may also simply transmit the information to other components, such as a decoder, database, or storage unit before the stored information is read. The data collected from the transponder 10 can either be sent directly to a host computer 80 through standard interfaces, it can be stored in the reader 50, or in a variety of desired storage locations and later uploaded to a computer for data processing. Uncoded information is preferably stored and retrieved in a similar manner, but need not be decoded before it is read.

In a further embodiment, the storage device, such as a RF-ID transponder, is placed within a railroad tie and is thus effective in environments with dirt, moisture and corrosion such as those related to railroad operations. By placing the storage device within the tie, the risk of loss or damage to the storage device is minimized. The invention is applicable to railroad ties comprising any material, including wood, concrete, gypsum, or molded composite material ties including, but not limited to ties made like U.S. Pat. No. 5,886,078 entitled Polymeric Compositions and Methods for Making Construction Materials From Them issued to Sullivan et al., and U.S. Pat. No. 6,828,373 issued to Sullivan et al., entitled Railroad Tie and Method for Making Same, and other composite material ties. For best performance, the transponder 10 should be located on or very near the upper surface of the tie and optimally oriented relative to the reader antenna. In one embodiment, the transponder 10 is molded into a composite tie when the tie is manufactured. In another embodiment, a recess or hole is formed in the tie, the transponder is placed in the recess, and is then sealed in place with epoxy or other like materials that are durable and will not interfere with the transmission of the signals, such as radio frequency waves. In another alternate embodiment, the transponders can be placed in a protective case and secured to the tie by holding members, such as adhesive and/or staples, bands, anchors, nails, screws, and the like as known or used by one skilled in the art. Preferably, such materials set within a few minutes or less. In another embodiment, a nail or spike containing a transponder 10 is driven into the tie. In still another embodiment, a screw containing a transponder 10 is driven into the tie. It should be appreciated that the exact positioning of the transponder may require various protection and/or insulation schemes to prevent distortion of or the interference with signals sent to or from the transponder 10.

When Low Frequency RF-ID is utilized and the transponder 10 is to be read, the reader 50 emits a power pulse, such as by way of example, a 134.2 KHz power pulse to the antenna 40 for a short time, preferably, less than about 1 second, such as a 134.2 KHz power pulse that lasts approximately 50 ms (charge or powering phase). This emission generates an electromagnetic field and is collected or received by the antenna 12 in or on the transponder 10 in or on the tie 120 that is tuned to the same frequency. This received AC energy is of alternating current (AC) and is rectified and stored on a small capacitor 15 within the transponder 10. When the power pulse has finished, as detected by the transponder, the transponder 10 immediately transmits back its stored data as a signal 20 using the energy stored within its capacitor as its power source; this is the read mode.

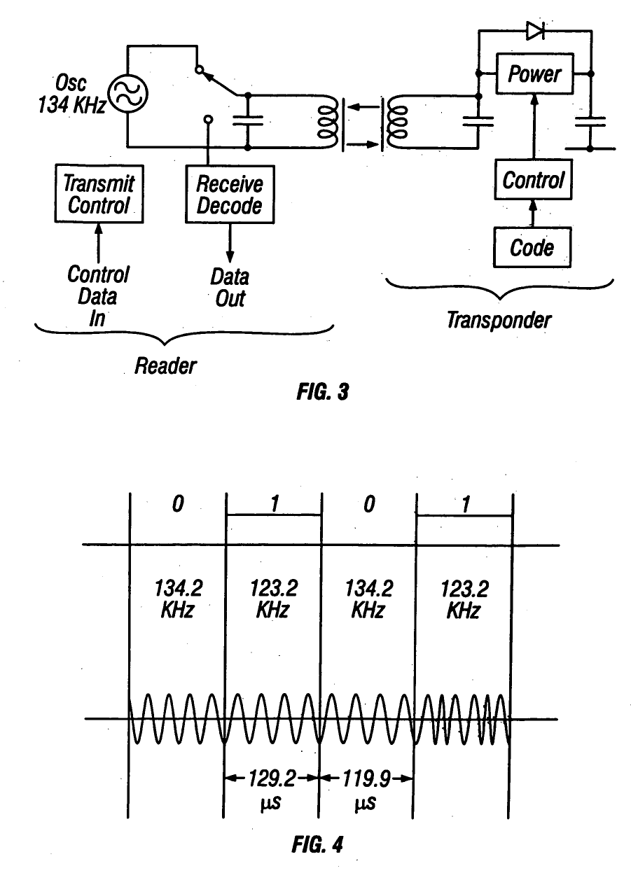

FIG. 3 is a circuit diagram for an RF-ID reader and transponder according to one embodiment of the invention. The amount and/or size of data varies and is based upon such factors as the type of storage device and the amount of stored information. In one embodiment, a total of 128 bits are transmitted (including error detection information) over a period of about 20 ms. This data is picked up by the receiving antenna 40 and read or decoded by the reader 50, or other decoding apparatus if the information is encoded. Once all the data has been transmitted, the storage capacitor is discharged, thus resetting the transponder 10 to make it ready for the next read cycle. The period between transmission pulses is known as the “sync time” and lasts between about 20 ms to about 50 ms, depending on the system setup. It should be appreciated that as technology advances, the sending, receiving, and/or storage of data may change dramatically allowing more data, more rapid transmission, as well as more reliable signal control. Thus, the instant invention will be modified, as technology advances, to utilize this technology and should not be viewed as a limitation herein.

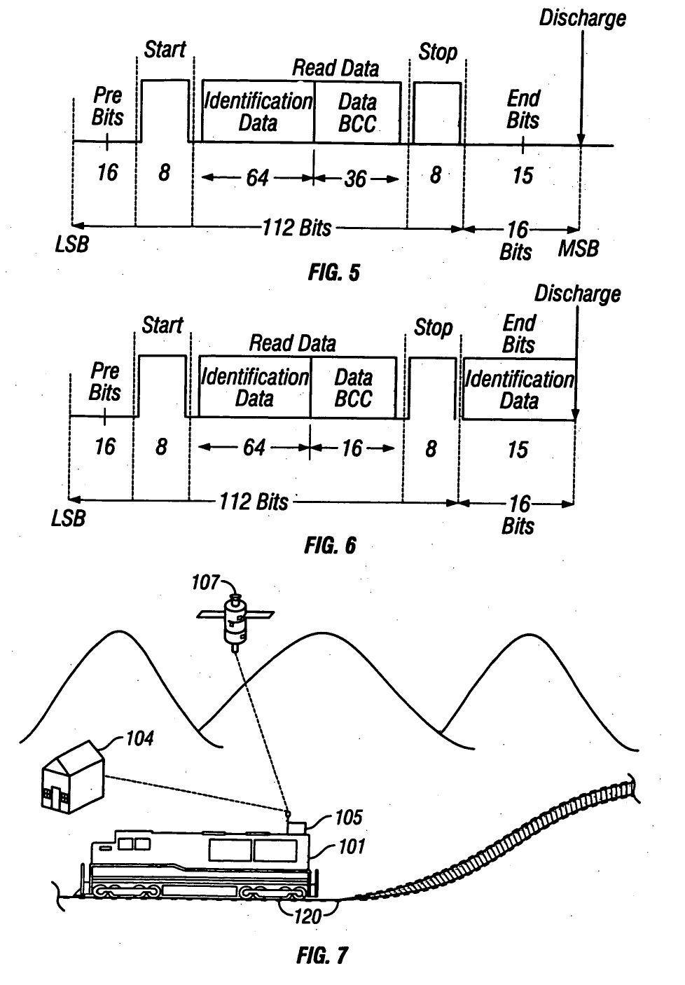

One transmission technique which may be used between the transponder 10 and the reader 50 is Frequency Shift Keying (FSK) with transmissions between 134.2 kHz and 123.2 kHz. The typical data low bit frequency is 134.2 kHz; the typical data high bit frequency is 123.2 kHz. The low and high bits have different duration, because each bit takes 16 RF cycles to transmit. The high bit has a typical duration of 130 microseconds, the duration of low bit is 119 microseconds. The FM principle used is illustrated in FIG. 4. Regardless of the number of low and high bits, the transponder response duration is usually less than about 20 ms (milliseconds). FIGS. 5 and 6 show the format of the received data for Read-Only (RO) and Read/Write (R/W) transponders, respectively.

A new identification number or other desirable data can be written (programmed) and stored into a R/W transponder in the following manner. After the charge phase the R/W transponder enters the Write mode, providing the reader starts to modulate the field by switching the transmitter on and off. Modulation index of this amplitude modification is preferably 100%. The duration of the off-phase defines whether a low bit or a high bit is being transmitted (Pulse Width Modulation). The writing is accomplished by the transponder shifting the received bits into a shift register. After the write phase, the reader's transmitter is switched on for a certain time (programming time) in order to energize the process of programming the shift register data into the EEPROM. All 80 bits are programmed simultaneously into the EEPROM. Once the data is programmed into the EEPROM, the transponder automatically sends back the captured data to the reader to allow a security check. This process takes place when the transmitter is switched off.

When High Frequency RF-ID is utilized, a transponder designed to operate with a 13.56 MHz carrier frequency is used. Down-Link communication (Reader to Transponder) is accomplished by pulse width modulation; Up-Link communication (Transponder to Reader) is implemented with sub-carrier modulation. Both Up and Down-Link are frame synchronized and CRC check-sum secured. The transponders have 256 bit non-volatile user memory with block-wise read/write capability. This memory is organized into 8 blocks. Each block has 32 user-programmable bits. Each transponder has a unique address that is 32 bits long (factory programmed). Some transponders in this class have a special feature called Simultaneous Identification—(SID). This feature allows multiple transponders to be read simultaneously, without collisions. The transponders with 2K bit memories (64 blocks of 32 bits each) can also be utilized.

In one embodiment of the invention, the transponder 10 is a High Frequency Transponder such as: Texas Instruments: RF-HDT-DVBB-NO, RI-I01-110A: TagSys, Inc: ARIO 40-SL. The high frequency readers are HF Readers: TI: RI-R00-321A, RI-STU-650A, and the high frequency antennas are HF Antennas: TI: RI-ANT-T01A. Other types and models of transponders that are known to one skilled in the art may also be used. Other types and models of readers and antennas known to one skilled in the art may also be used.

In another embodiment of the invention, the transponder 10 is a Low Frequency Transponder such as TI: RI-TRP-WR2B, RI-TRP-RR2B (read only); RFID, Inc.: 1775LG, and the low frequency (LF) Readers: TI: RI-RFM-007B; RFID, Inc.:3037E (hand held), and the low frequency (LF) Antennas: TI: RI-ANT-G01A, RI-ANT-P02A (ferrite rod). Other types and models of transponders, readers, and antennas that are known to one skilled in the art may also be used.

The maximum feasible reading distance between the reader and the transponder (Low Frequency or High Frequency) depends on many factors including, but not limited to, the transponder/reader type, the electromagnetic noise, the transponder orientation, the antenna type, the available technology, the future technology advances, and government regulations. In general, a standard 32 mm glass capsule can be read with a stationary reader and a gate antenna from a distance of up to about 1 meter. Larger transponders can achieve ranges of up to about 2 meters with handheld readers offering lower ranges up to about 250 mm.

In some embodiments, the system uses a 16-bit Cyclic Redundancy Check algorithm (CRC-CCITT), which ensures that only valid data is sent from the reader to its associated controller.

The antennas can consist of ferrite rod (Low Frequency only) gate types, and other types known to one skilled in the art. Each antenna has its own specific readout pattern (i.e., the electromagnetic field emanating from the transponder during its reply stage). The shape and size of this pattern depends on the specific readout antenna selected and government regulations that define the magnitude and amount of electromagnetic field strength that can be generated. Electromagnetic noise in the environment can also affect readout ranges.

Many applications require that transponders attached to objects be read while traveling at specific speeds with respect to the readout antenna. Since a standard (Low Frequency) stationary reader completes one read in approximately 120 ms, the transponders must remain in the boundaries of a readout pattern for at least that amount of time. As a guide, 32 mm transponders can be read at typically about 3 m/s using the appropriate reader and antenna. With larger antennas, automatic data capture has been performed successfully at read speeds of about 65 m/s (about 150 mph, 240 km/h).

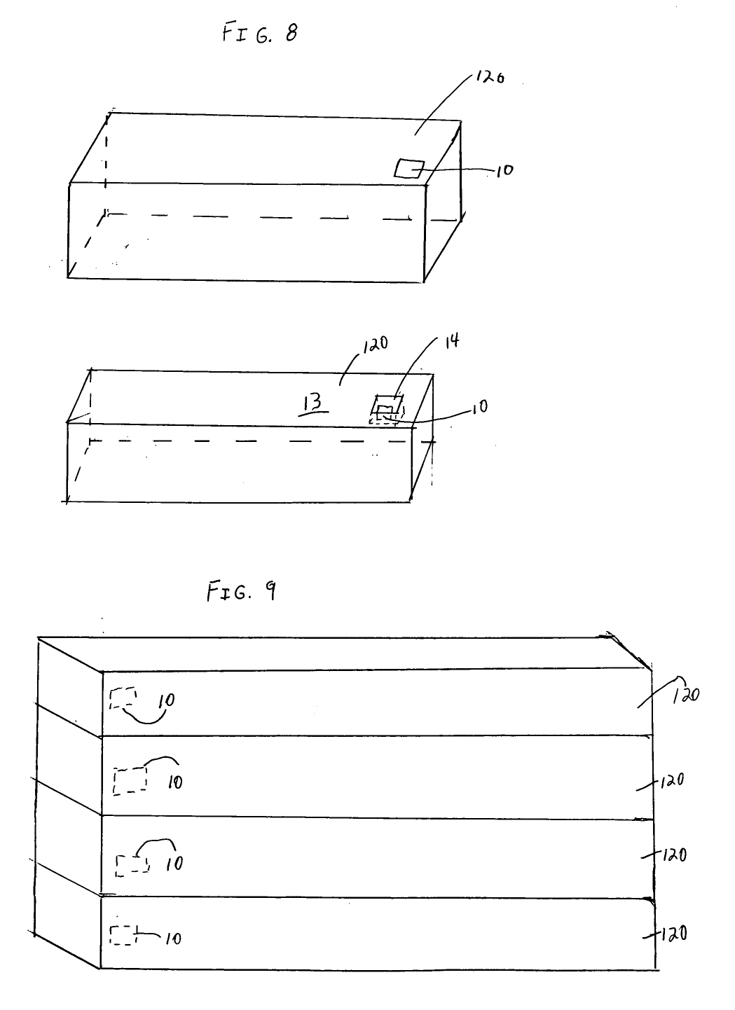

FIG. 7 illustrates an alternative embodiment of the invention in which the data collected from the transponder 10 by the reader 50 is transmitted by radio signals from the transmitter/receiver 105 to a receiver and computer located in the remote station 104. In a further embodiment, a satellite global positioning system (GPS) is utilized to determine the geographical locations of the ties 120 as their transponders 10 are being read by the reader 50. The signals from the satellites 107 are received by the transmitter/receiver 105 aboard the rail car 101. A computer utilizes the triangulation method to continuously determine the geographical location of the rail car, and thus of each of the ties 120 being read by the RF-ID reader 50. In this embodiment, information concerning the precise locations of the ties 120 is recorded together with the historical data collected from the tie transponders 10. The location information obtained on the ties 120 facilitates maintenance, repair or replacement of the ties 120 as needed.

Although the invention is described herein as it might be used for storing and retrieving information regarding railroad ties, it will be understood that the present invention is applicable for use with support and structural members particularly, but not limited to, those used in construction and supporting applications in buildings, tunnels, bridges and also in marine, aviation, and aerospace technologies, and is not limited in its application to railroad ties or to railroad track components. It will be understood that the present invention is not limited to the use of radio frequency devices for wireless reading of stored information. The invention includes within its scope the use of alternative information storage and wireless transmission devices, such as other machine readable tag and label systems including 1 and 2-dimensional bar code reading/writing systems. It will also be understood that the invention includes the installation of more than one type of readable device in the tie for permitting the user some flexibility in the choice of reader technology to be used.

FIG. 8 illustrates a typical railroad tie 120 with the attached storage device or transponder 10. In a preferred embodiment, the device 10 is embedded below the surface 13. In a molded or formed tie 120, a recess 14 can be molded to hold the transponder 10. Also, the recesses 14 can be cut out in both molded ties or ties of different construction. Preferably, the transponder 10 and the recess 14 or cut out would be sealed. The sealing material is preferably one that would not interfere with signals transmitted to or from the transponder 10. As discussed herein above, many other methods of attaching the transponder 10 to the tie 120 can be utilized.

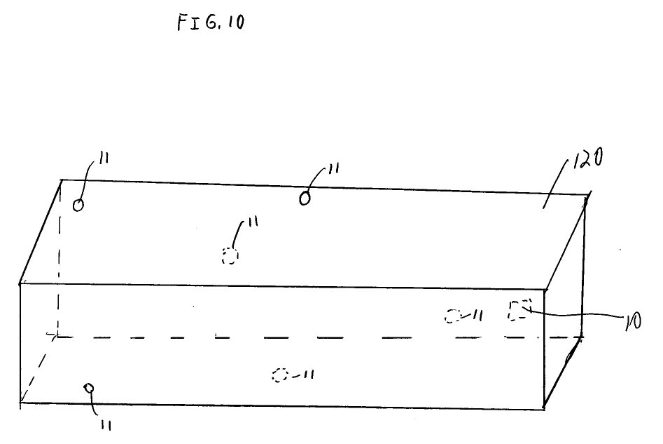

FIG. 9 illustrates a typical manner of storing the ties 120 prior to the installation of the ties 120. The ties 120 are preferably stacked so as to minimize any chance of damage to the transponders 10 and also so as to allow the transponder 10 to be read or to allow initial information to be programmed into the transponder 10 or to allow additional information to be programmed such as, but not limited to, the buyer of the ties 120, where the ties 120 are to be shipped, where the ties 120 are to be used, or any other desired information.

FIG. 10 illustrates another embodiment of the present invention wherein a sensor 11 is used to determine some features of the tie 120. These features preferably include, but are not limited to, the condition of the tie 120, any appreciable wear of the tie 120, the amount of movement of the tie 120 (i.e. to ensure that the tie 120 is supported sufficiently so that when a train passes over the tie 120 it does not move more than an acceptable distance), or any other desired feature. Preferably, the sensor 11 would be able to detect the amount of material worn or otherwise removed from the tie 120 due to such conditions as erosion, breaks, scratches, impacts, and the like. Those skilled in the art would appreciate that preferably more than one sensor 11 would be used so as to detect desired features throughout the tie 120 or be placed in particular areas of concern, such as but not limited, to the areas that undergo the most stress whenever a train or heavy vehicle crosses them. The sensor or sensors 11 could be attached to the exterior of the tie 120 or could be embedded within the tie 120. The method of attachment should not be viewed as a limitation herein as different sensors 11 may be better adaptable to certain positioning. Preferably, the sensor or sensors 11 would work in conjunction with the transponder 10 by sending data to the transponder 10 or by being read simultaneously with the transponder 10. The data, from the sensor 11, can either be “raw” data directly from the sensor 11 which can be further processed when the transponder signal is read or it can be a more intelligent sensor 11 which processes any retrieved data and provides a more refined output that can be deciphered without further processing. It should be appreciated that methods of detection are known in the art and therefore are not further detailed herein.

The apparatus and method for storing and retrieving information about railroad ties and railroad track components of the present invention, and many of its intended advantages, will be understood from the foregoing description of example embodiments. Further, it will be understood that certain features and sub-combinations are of utility and may be employed without reference to other features and sub-combinations. This is contemplated by and is within the scope of the claims. It may be seen from the preceding description that a novel method and apparatus for tracking structural or railroad components, such as but not limited to, railroad ties has been provided. Although specific examples may have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. An apparatus for storing and retrieving information about a railroad track crosstie component comprising:
(a) a railroad crosstie;
(b) a transponder attached to said railroad crosstie;
(c) said transponder storing inputted data, wherein the inputted data is data selected from the group of data consisting essentially of manufacturing data, installation data, composition data, use data, historical data, or any combination thereof; and
(d) a reader for retrieving the stored inputted data from the transponder.

2. The apparatus of claim 1, wherein the railroad crosstie is a molded component.

3. The apparatus of claim 1, wherein the affixed transponder is embedded in the railroad component.

4. The apparatus of claim 1, wherein the affixed transponder is affixed to an outer surface of the railroad component.

5. The apparatus of claim 1, wherein the reader is capable of generating radio frequency waves, and wherein the transponder broadcasts the information stored therein in response to radio frequency waves received from the reader.

6. The apparatus of claim 1, wherein the transponder is a read-only transponder.

7. The apparatus of claim 1, wherein the transponder is a read/write transponder, and wherein the reader can reencoding the transponder with new and/or revised information transmitted by the reader.

8. The apparatus of claim 1, wherein the reader is carried by a rail car so that the reader moves within radio frequency (R.F.) activating range of the transponder when the rail car passes said transponder.

9. The apparatus of claim 1, wherein the transponder comprises a data source, and wherein the data source stores inputted data and allows retrieval of said data when queried for by said reader.

10. An apparatus for storing information associated with a railroad tie comprising:
(a) a molded railroad tie; and
(b) an information storing device affixed to or embedded in said molded railroad tie, wherein the stored information comprises information about the manufacturer or use of the tie, and wherein the stored information can be retrieved and/or transmitted.

11. The apparatus of claim 10, wherein the information storing device comprises a readable transponder.

12. The apparatus of claim 10, wherein the transponder is a read/write transponder, and wherein the writer enables the transponder to store new or revised information.

13. The apparatus of claim 12, further comprising a reader to retrieve the stored information.

14. The apparatus of claim 11, wherein the transponder is radio frequency sensitive to at least one frequency, and wherein the reader is capable of retrieving the information from the storing device at one or more radio frequencies.

15. The apparatus of claim 14, further comprising a reader for retrieving the information from the information storing device.

16. The apparatus of claim 11, wherein the reader is carried by a rail car and said reader moves within radio frequency (R.F.) activating range of the transponder when the rail car passes over any ties having transponders.

17. The apparatus of claim 13, wherein the reader is portable and is used manually.

18. The apparatus of claim 10, wherein the information storing device is affixed to the surface of the railroad tie by at least one holding member and/or glue.

19. The apparatus of claim 10, wherein the information storing device is placed within said tie during manufacturing or after the tie is fabricated.

20. The apparatus of claim 10, wherein stored information can be transmitted to a remote location where it is then read and/or stored in a database.

21. The apparatus of claim 10, further comprising a global positioning system (GPS) for recording the geographical location of the tie and/or for finding the tie.

22. The apparatus of claim 10, further comprising at least one sensor within or upon said tie to determine tie condition and/or wear.

23. The apparatus of claim 10, wherein said stored information about the manufacture comprises the date of manufacture, composition of tie material, identity of manufacturer, quality control data, place of manufacture, tie identification or a combination of the foregoing.

24. The apparatus of claim 10, wherein the stored information is further comprised of the date of sale, name of purchaser, date of installation, location of installation, identity of installer, or any combination thereof.

25. A method for storing and retrieving information concerning a railroad tie, which comprises:
(a) providing a railroad tie;
(b) affixing or embedding a transponder to the railroad component, said transponder having a memory;
(c) storing information about the tie within the transponder; and
(d) retrieving and/or transmitting stored information from the transponder.

26. The method of claim 25, further comprising the step of reading the stored information.

27. The method of claim 26, further comprising the step of storing additional information and/or revising the stored information.

28. The method of claim 25, wherein reading the information from the transponder comprises:
(a) subjecting the transponder to a radio frequency wave field for energizing the transponder and causing the energized transponder to transmit the information stored therein; and
(b) receiving and storing the transmitted information in the transponder.

29. The method of claim 28, wherein subjecting the transponder to a radio frequency wave field comprises:
(a) moving a radio frequency generating reader in proximity to the transponder; and
(b) energizing the reader for producing the radio frequency wave field, thereby transmitting the stored information to the reader.

30. The method of claim 28, wherein the transmitted information is received by a radio frequency sensitive reader through an antenna in said transponder.

31. The method of claim 25, further comprising the steps of:
(a) encoding the information prior to storage; and
(b) decoding the stored information before said information can be read.

32. The method of claim 25, further comprising the step of transmitting the retried information to a computer.

33. The method of claim 25, further comprising the step of encrypting the information prior to storage.

34. The method of claim 29, further comprising the step of storing the retrieved information in the reader.

35. The method of claim 34, further comprising the step of transferring the uploading the information stored information from the reader to a computer for data processing and/or archival.

36. The method of claim 25, wherein the railroad component comprises a railroad tie, and wherein the transponder is affixed to the railroad tie by forming a recess in the tie, placing the transponder in the recess, and sealing the recess.

37. The method of claim 25, wherein the transponder is embedded in the tie when the tie is manufactured, or after manufacture by driving a member that holds the transponder into the tie.

38. The method of claim 25, wherein the transponder is placed in a protective case and is then secured to the tie by a holding member.

39. The method of claim 25, wherein information is stored in the transponder before the transponder is affixed to the tie or embedded in the tie.

40. The method of claim 31, wherein the encoding of the transponder with additional information comprises the steps of:
(a) placing the transponder into a write mode;
(b) transmitting the additional information to the transponder from the reader or a writing device; and
(c) storing the additional information in the transponder.

41. The method of claim 40, further including the step of retransmitting the stored additional information from the transponder to the reader or writer device to verify the accuracy of the additional encoded information.

42. The method of claim 25, further comprising the steps of:
(a) providing a sensor that is capable of determining tie condition;
(b) placing the sensor in the tie or upon the tie;
(c) allowing the sensor to determine tie condition; and
(d) transmitting the information to a transponder for storage or a reader.

43. The method of claim 40, wherein the information to be stored is also transmitted by radio signals to a receiver in a remote location and then uploading the information to a computer for data processing.

44. The method of claim 25, further comprising the steps of:
(a) providing a global positioning system to determine the geographical location of the railroad component; and
(b) storing the location information in the transponder.

45. The method of claim 44, further comprising the step of transmitting the location information from the transponder and other stored information to a remote station.

46. The method of claim 43, wherein the information is transmitted by radio signals to a receiver in the remote station, and further including uploading the information to a computer for data processing.
